(19) United States
(12) Patent Application Publication
(10) Pub. No.: US 2023/0241747 A1
(43) Pub. Date: Aug. 3, 2023

(54) SOCKET WRENCH EXTENSION WITH FLANGE

(71) Applicant: Stephen D. ALBIN, Los Altos, CA (US)

(72) Inventor: Stephen D. ALBIN, Los Altos, CA (US)

(21) Appl. No.: 18/101,505

(22) Filed: Jan. 25, 2023

Related U.S. Application Data
(60) Provisional application No. 63/305,566, filed on Feb. 1, 2022.

(51) Int. Cl. B25B 23/00

(52) U.S. Cl. CPC B25B 23/0021; B25B 23/0035; B25B 13/46

(57) ABSTRACT

An extension for use with a socket wrench is provided. A drive socket is at a first end of the extension. A hexagonal prism surrounds the drive socket and extends from the first end of the extension towards a second end of the extension. A flange with a knurled edge is at a second end of the hexagonal prism. A tool gripping flange is between the flange with the knurled edge and the second end of the extension. A male drive is at the second end of the extension.

### CLAIM OF PRIORITY

This application claims priority to Provisional Application No. 63/305,566 dated Feb. 1, 2022, the contents of which are incorporated herein by reference in their entirety.

### BACKGROUND OF THE INVENTION

### Field of the Invention

The present disclosure relates to socket wrench extension. In particular, the present disclosure relates to extension bars for socket wrench extensions for ratchet wrenches.

### SUMMARY

To achieve the foregoing and in accordance with the purpose of the present disclosure, an extension for use with a socket wrench is provided. A drive socket is at a first end of the extension. A hexagonal prism surrounds the drive socket and extends from the first end of the extension towards a second end of the extension, wherein a first end of the hexagonal prism is at the first end of the extension. A flange with a knurled edge is at a second end of the hexagonal prism. A tool gripping flange is between the flange with the knurled edge and the second end of the extension. A male drive is at the second end of the extension.

These and other features of the present disclosure will be described in more detail below in the detailed description of the disclosure and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates various views of an extension in an embodiment.

FIG. 2 illustrates various views of an extension in another embodiment.

FIG. 3 illustrates various views of an extension in another embodiment.

FIG. 4 illustrates another embodiment.

### DETAILED DESCRIPTION OF THE PREFERRED EMBODIMENTS

The present disclosure will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In the use of socket wrenches an extension bar may be used to provide increased access to nuts and bolts. The socket wrench would be placed on one end of the extension bar and a socket would be placed at the opposite end of the extension bar. The socket would engage with a nut or bolt. A socket wrench such as a ratchet wrench would be used to apply a rotational force on the extension bar, which would provide a rotational force on the socket in order to rotate the nut or bolt. The application of the rotational force by the socket wrench may be unstable, causing the socket to slip off of the nut or bolt.

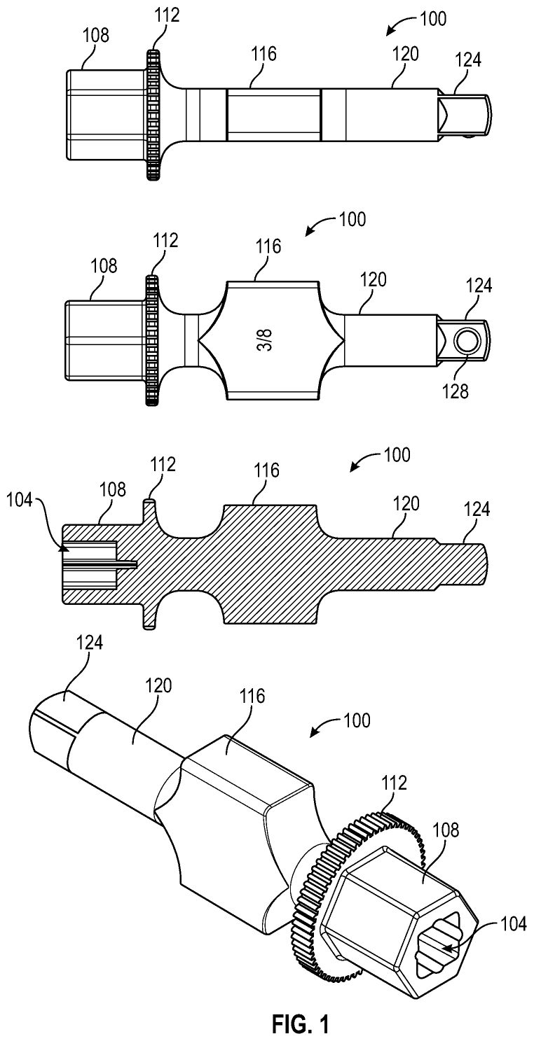

FIG. 1 provides various views of a socket wrench extension that provides improved control and stability that helps prevent slipping of the socket from the nut or bolt and allows additional rotational force and thus a higher torque to be applied to the nut or bolt to through the socket. A wrench drive socket 104 is at a first end of the extension 100. The wrench drive socket 104 has dimensions to fit the male drive of the wrench. In this example, the wrench provides a ⅜ inch square drive. So, the wrench drive socket 104 is a ⅜ inch square hole. In this embodiment, a hexagonal prism 108, with a ¾ inch width, is formed around the ⅜ inch square drive, where a first end of the hexagonal prism 108 is at the first end of the extension 100 and wherein the hexagonal prism 108 extends from the first end of the extension 100 towards the second end of the extension 100 to a flange with a knurled edge 112. In this embodiment, the flange with the knurled edge 112 has a generally circular cross-section with a diameter of about 1.13 inches. Between the flange with a knurled edge 112 and the second end of the extension 100 is a tool gripping flange 116. In this embodiment, the tool gripping flange 116 has a thickness about equal to a diameter of a bar 120 forming part of the extension 100. In this embodiment, the tool gripping flange 116 has a thickness of about ½ inches, a length of about 0.88 inches, and a width of about 0.88 inches. In this embodiment, the bar 120 extends from the tool gripping flange 116 to a male drive 124 formed by the second end of the extension 100. In this embodiment, a detent ball 128 is provided as part of the male drive 124 to help prevent a socket from falling off. Similarly, a detent hole may be formed in the sides of the wrench drive socket 104 to provide a connection with the wrench. In this embodiment, the male drive 124 is a ⅜ inch square drive. In this embodiment, the extension 100 is 4 inches long. In other embodiments, the extension 100 may have other lengths, such as being 6, 8, or 10 inches long.

In operation, a ratchet wrench is connected to the first end of the extension 100 by placing a male part of the ratchet wrench into the wrench drive socket 104. A socket is placed on the male drive 124 of the extension. The socket is placed over a nut or bolt. To facilitate placement, the flange with the knurled edge 112 may be gripped by hand. A wrench or pliers may be used to grip either the hexagonal prism 108 or tool gripping flange 116 to provide additional stability of extension 100 and additional rotational force on the nut or bolt. In an application, the handle of the ratchet wrench and the handle of a wrench used to grip the tool gripping flange 116 may make an angle of approximately 180°. Such a configuration provides increased stability and force in turning the nut or bolt.

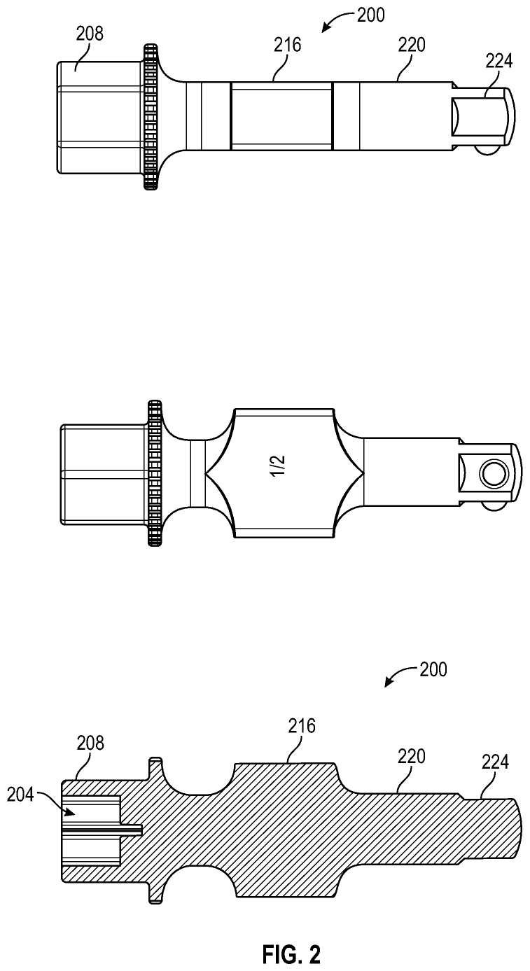

FIG. 2 illustrates another embodiment of an extension 200. In such an embodiment, a wrench drive socket 204 is a ½ inch square hole. In this embodiment, a hexagonal prism 208 is formed around the ½ inch square drive. The hexagonal prism 208 has a width of 0.88 inches. The tool gripping flange 216 has a thickness about equal to the diameter of the bar 220, which is about 0.6 inches. The extension has a male drive 224 which is a ½ inch square drive. In some embodiments, other dimensions may be about the same as the dimensions in the embodiment shown in FIG. 1.

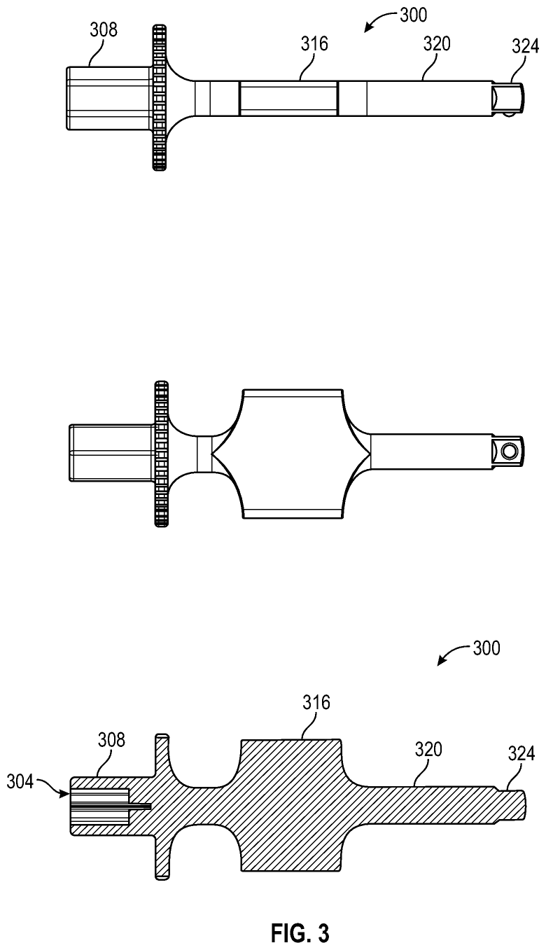

FIG. 3 illustrates another embodiment of an extension 300. In such an embodiment, a wrench drive socket 304 is a ¼ inch square hole. In this embodiment, a hexagonal prism 308 is formed around the ¼ inch square drive. The tool gripping flange 316 has a thickness about equal to the diameter of the bar 320, which is about 0.32 inches. The extension has a male drive 324 which is a ¼ inch square drive. In some embodiments, other dimensions may be about the same as the dimensions in the embodiment shown in FIG. 1.

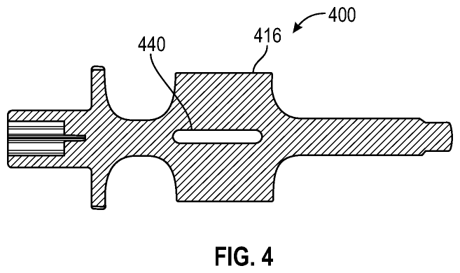

FIG. 4 illustrates another embodiment of an extension 400. The tool gripping flange 416 has a slot 440 passing through the tool gripping flange 416. A screwdriver or pry bar may be placed in the slot to provide a lever for rotating the extension 400.

While this disclosure has been described in terms of several preferred embodiments, there are alterations, modifications, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, modifications, permutations, and various substitute equivalents as fall within the true spirit and scope of the present disclosure.

What is claimed is:

1. An extension for use with a socket wrench, wherein the extension comprises:
a drive socket at a first end of the extension;
a hexagonal prism surrounding the drive socket extends from the first end of the extension towards a second end of the extension;
a flange with a knurled edge at a second end of the hexagonal prism;
a tool gripping flange between the flange with the knurled edge and the second end of the extension; and
a male drive at the second end of the extension.

2. The extension, as recited in claim 1, further comprising a slot through the tool gripping flange.

3. The extension, as recited in claim 1, wherein a first end of the hexagonal prism is at the first end of the extension.
